(19) United States
(12) Patent Application Publication
(10) Pub. No.: US 2026/0336766 A1
(43) Pub. Date: Oct. 29, 2026

(54) METHOD AND FLOATING VESSEL CONTAINING PLANTS FOR IN SITU TREATMENT OF POLLUTION IN WATERWAYS

(71) Applicants: THANH XUAN BUI, HO CHI MINH (VN); KIM QUYEN THI VO, HO CHI MINH (VN); YEN NHI PHAM TRAN, HO CHI MINH (VN)

(72) Inventors: THANH XUAN BUI, HO CHI MINH (VN); KIM QUYEN THI VO, HO CHI MINH (VN); YEN NHI PHAM TRAN, HO CHI MINH (VN)

(73) Assignees: VIETNAM NATIONAL UNIVERSITY HO CHI MINH CITY, HO CHI MINH (VN); HO CHI MINH CITY UNIVERSITY OF TECHNOLOGY - VNUHCM, HO CHI MINH (VN)

(21) Appl. No.: 19/652,007

(22) Filed: Apr. 20, 2026

(30) Foreign Application Priority Data
Apr. 24, 2025 (VN) 1-2025-02820

(51) Int. Cl. B63B 35/32; C02F 3/32; C02F 103/00

(52) U.S. Cl. CPC B63B 35/32; C02F 3/32; C02F 2103/007

(57) ABSTRACT

A method and a floating vessel for treatment of polluted water in waterways are disclosed. The method includes the steps of (a) preparing a floating vessel that has a plurality of plant pots, aerators, sensors, cameras, a controller box, and a plurality of vertical and horizontal hollow tubes; (b) moving the floating vessel to a first polluted location; (c) growing canna lily (Canna generalis), Umbrella papyrus (Cyperus alternifolius), fragrant sedge (Cyperus ordoratus) in the plurality of plant pots; (d) allowing the plants remedy the polluted water; and (e) aerating and guiding the water through plurality of vertical and horizontal hollow tubes.

### CROSS-REFERENCE TO RELATED APPLICATION

This application is based upon and claims priority to a patent application No. 1-2025-02820 entitled “ [symbol] [symbol] [symbol] [symbol] [symbol] [symbol] [symbol] [symbol] [symbol] [symbol] [symbol] [symbol] by Thanh Xuan Bui, filed in Apr. 24, 2025 in the Republic Socialist of Vietnam. The entire content of which is incorporated herein by reference.

### FIELD OF THE INVENTION

The present invention relates generally to a floating vessel for the treatment of pollution in waterways. More specifically, the present invention relates to floating vessel carrying plants designed for treatment of pollution in waterways.

### BACKGROUND ART

Surface water pollution in rivers, lakes, canals, and streams in major cities is causing much concern and is considered one of the serious environmental problems. At low tide, surface water contains a lot of suspended sediment, often appearing black and emitting an unpleasant odor. Components such as organic matter, pathogenic microorganisms, suspended solids, heavy metals, solid wastes, chemical residue or effluent are present in the waterways. In particular, nitrogen and phosphorus levels detected in the water source are quite high, exceeding the water intake standards by 10-20 times. High nitrogen content in water leads to the accumulation of ammonia nitrogen (NH₃) in canals and ditches, causing toxicity to aquatic life and eutrophication.

Today, wastewater management and treatment are an extremely important issue requiring investment in appropriate infrastructure. Current wastewater treatment technologies such as conventional activated sludge, anaerobic combined aerobic and anoxic treatment systems, membrane bioreactors, etc., all have potential but require relatively high investment costs and additional land area for construction. Therefore, it is necessary to find solutions that reduce costs and have no requirement of construction area and are environmentally friendly. Current research shows that floating treatment wetland (FTW) technology is becoming a popular choice due to its many advantages.

Floating Vegetation Treatment Rafts (FTWs) are an improved version of Constructed Wetland (CW) technology, where plants grow without soil on a support frame and floating buoys. The plant roots spread throughout the frame and sink into the water, forming dense root columns with a large surface area.

Plants are known not only absorb nutrients and pollutants themselves, but their roots and floating frame materials also provide ample surface area for bacteria to grow, forming a biofilm. This biofilm is where most of the nutrient absorption and degradation takes place in floating plant-based remediation systems. There exist different FTW apparatus to treat water pollution in the world.

In the British Patent No. GB2588871B, an ecological floating island device (the '871 device) is disclosed for the treatment of black and foul-smelling water was disclosed. The '871 device comprises biological support modules and plant growing modules installed in the body of the floating island tank. Pneumatic impellers installed on the floating island device drive a wind-powered air compressor to generate compressed air and the compressed air is stored in a compressed air tank. The compressed air in the compressed air tank provides rotational force, movement, aeration and water flow into and out of the body of the floating island tank to complete the treatment of black and foul-smelling water. However, the '871 device is not efficient because the wind powered air compressor does not generate enough power to move the floating island land that is submerged deeply in sluggish water (“black and odorous water”), especially during hot and windless days.

In another approach, the Chinese patent application number CN103359834A describes an ecological floating raft made of composite material incorporating aeration and wind turbines to supply aquatic plants in baskets arranged on the floating raft to remove organic pollutants and nutrient salts in slow-flowing water bodies. Its advantages include a simple structure, economy, and practicality, making it suitable for treating and restoring polluted urban water bodies such as rivers and lakes. However, the '834A floating raft was focused on expensive composite material as a floating island and artificial aeration by wind turbines.

Yet in another approach, the Chinese patent application number CN104628145A discloses a floating bed made of composite material, with the floating body fixed on a support frame equipped with channels containing biological media and a mesh for growing plants on the floating bed; and a biological membrane suspended below the support frame. The floating bed is aerated and oxygenated via an air compressor and aeration pipes to treat polluted water, prevent suspended solids, and act on nitrogen, phosphorus, COD, and other pollutants.

All of the above prior-arts failed to select plants that

Therefore, there is a need for a floating raft that employs native plants whose roots can purify polluted waterways.

There is a need for a floating raft that employs natural and inexpensive materials as buoyant.

There is a need for a floating raft that are mobile, efficiently moving along the polluted waterways.

There is a need for a method for cleaning polluted waterways that are light, inexpensive, and using native plants that are best for rhizofiltration, phytotransformation, nutrient cycling, and oxygenation.

The methods and floating rafts of the present invention meets the above needs and solve the above-described requirements.

### SUMMARY OF THE INVENTION

Accordingly, an object of the present invention is to provide a method and a floating vessel for treatment of polluted water in waterways are disclosed. The method includes the steps of (a) preparing a floating vessel that has a plurality of plant pots, aerators, sensors, cameras, a controller box, and a plurality of vertical and horizontal hollow tubes; (b) moving the floating vessel to a first polluted location; (c) growing canna lily (Canna generalis), Umbrella papyrus (Cyperus alternifolius), fragrant sedge (Cyperus ordoratus) in the plurality of plant pots; (d) allowing the plants remedy the polluted water; and (e) aerating and guiding the water through plurality of vertical and horizontal hollow tubes.

An another object of the present invention is to provide a floating vessel containing plants for the treatment of organic pollution in water capable of floating and moving on urban canals and rivers including: i) a support frame consisting of multiple vertical support bars connected to multiple horizontal support bars to arrange force distribution devices and create buoyancy; ii) A system of multiple trays arranged in horizontal and vertical rows and fixed on the support frame for growing plants; each tray consists of many hollow compartments to contain and hold plants and allow the plant roots to come into contact with the water environment to process organic matter in the water; various types of plants are grown alternately on the trays, including: Canna lily (Canna generalis), umbrella sedge (Cyperus alternifolius), and fragrant flatsedge (Cyperus ordoratus); and iii) air ducts running along the length of the floating vessel; and connected to numerous branch air ducts arranged horizontally across the width of the floating vessel, providing air to increase dissolved oxygen in the water and enhance the ability to treat organic pollutants in urban rivers, ponds, or canals.

Another object of the present invention is to provide a water treatment floating vessel that can retaining water quality data and communicating them to a control center for analysis.

Another object of the present invention is to provide a water treatment floating vessel that can autonomously move to different polluted locations of the waterway.

These and other advantages of the present invention will no doubt become obvious to those of ordinary skill in the art after having read the following detailed description of the preferred embodiments, which are illustrated in the various drawing and figures.

### BRIEF DESCRIPTION OF THE DRAWINGS

The accompanying drawings, which are incorporated in and form a part of this specification, illustrate embodiments of the invention and, together with the description, explain the principles of the invention.

FIG. 1 is a perspective diagram showing the floating vessel operative to detect and move to polluted section of a waterway in accordance with an aspect of the present invention;

FIG. 2 is a plan view of a floating base designed to containing accessories and plants for treating organic pollution in water in accordance with an exemplary embodiment of the present invention.

FIG. 3 is a side view of a complete floating vessel with electronic controller, aeration device and special plants selected to in situ treat polluted water in accordance with an exemplary embodiment of the present invention.

FIG. 4 is a schematic diagram of the controller box equipped to control the floating vessel in accordance with an exemplary embodiment of the present invention.

FIG. 5 is a schematic diagram of the microprocessor having a decision unit (DU) operative to decide whether a section of a waterway is polluted in accordance with an exemplary embodiment of the present invention;

FIG. 6 is a flow chart of a method for in situ treatment of polluted waterways in accordance with an exemplary aspect of the present invention;

FIG. 7A is a graph showing the change in pH value for 14 weeks in a waterway at low tide using the floating vessel and method in accordance with an exemplary aspect of the present invention;

FIG. 7B is a graph showing the change in pH value for 14 weeks in a waterway at low tide using the floating vessel and method in accordance with an exemplary aspect of the present invention;

FIG. 8A is a graph showing the change in dissolved oxygen (DO) value for 14 weeks in a waterway during high tide cycle using the floating vessel and method according to an exemplary aspect of the invention;

FIG. 8B is a graph showing the change in dissolved oxygen (DO) value for 14 weeks in a waterway during low tide cycle using the floating vessel and method according to an exemplary aspect of the invention;

FIG. 9A is a graph showing the growth of canna lily (Canna generalis) on the floating vessel for 14 weeks of operation according to an exemplary aspect of the present invention.

FIG. 9B is a graph showing the growth of Umbrella papyrus (Cyperus alternifolius) on the floating vessel for 14 weeks of operation according to an exemplary aspect of the present invention.

FIG. 10A is a graph showing the change in chemical oxygen demand (COD) value for 14 weeks in a waterway during high tide cycle using the floating vessel and method according to an exemplary aspect of the invention.

FIG. 10B is a graph showing the change in chemical oxygen demand (COD) value for 14 weeks in a waterway during low tide cycle using the floating vessel and method in accordance to an exemplary aspect of the invention

The above figures are for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Within the scope of the present description, the words “securing means” includes ties, fasteners, locks, crews, nails, tongs, prongs, bolts, hinges, hex sockets, clips, rivets, levers, cams, grommets, staples, nuts, buttons, sleeves, lugs, handles, bars, connectors, or the likes.

Within the scope of the present invention, reference to “an embodiment” or “the embodiment” or “some embodiments” means that a particular feature, structure, or element described with reference to an embodiment is comprised in at least one embodiment of the described object. The sentences “in an embodiment,” “in the embodiment,” or “in some embodiments” in the description do not, therefore, necessarily refer to the same embodiment or embodiments. The features, structures, or elements can be furthermore combined in any adequate way in one or more embodiments.

The present invention provides a floating vessel and method for treating pollution in waterway equipped with plants whose roots can absorb organic pollution, aerator designed to provide energy to stagnate water, and electronic controller for operating the floating vessel.

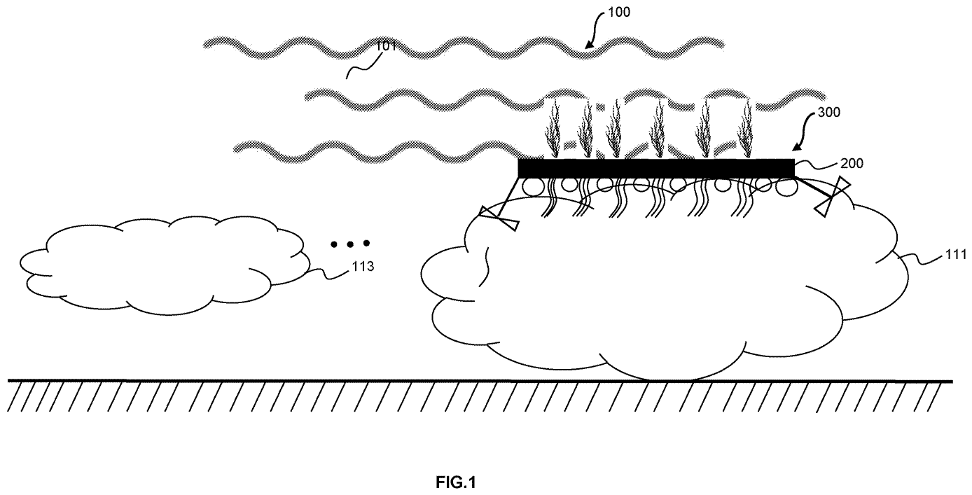

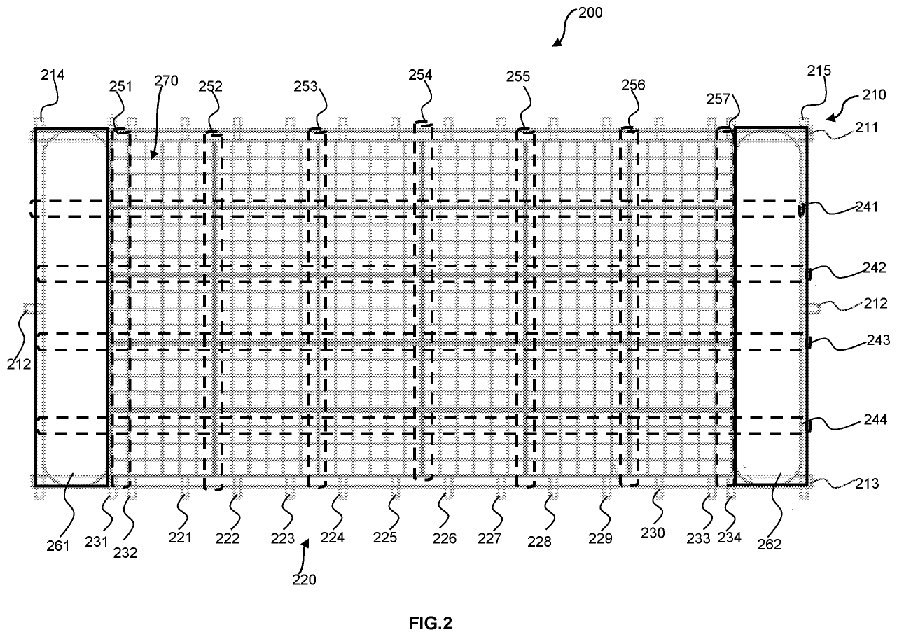

First referring to FIG. 1, a perspective diagram 100 demonstrating the operation of a floating vessel in accordance with an exemplary embodiment of the present invention is illustrated. A floating vessel 300, of the present invention whose detailed structure will be disclosed fully in FIG. 2-FIG. 5, uses particular phytoremediation plants in combination with turbulence aeration to reduce pollutants. Special types of phytoremediation plants that are researched and selected to use in floating vessel 300. These plants can reduce the concentrations of toxic effects of contaminants in the water of polluted area 111. More specifically, the umbrella sedge (Cyperus alternifolius) is selected and it belongs to the sedges family that can collect copper (Cu), manganese (Mn), nitrogen

$$( {NH}_{4}^{+} - N ) ,$$

and phosphorus

$$( {PO}_{4}^{3 -} ) ;$$

and achieve high removal rates for pollulants: CDO (67%-83%), TSS (61.7%). Another plant is selected is the canna lily (Canna generalis) that can remove lead (Pb), carbon (C), nitrogen (N), and phosphor (P) (CNP). Canna lily can also reduce biochemcial oxygen demand (BOD) and chemical oxygen demand (COD more than 50%). BOD and COD measure organic pollution in water with higher values indicating higher pollution. BOD measures the oxygen used by microorganisms to decompose organic matter. COD measures oxygen required from chemical oxidation of organic compounds. Fragrant fledge or fragrant flatsedge (Cyperus odoratus) is highly efficient plant widely used in phytoremediation, particularly to wastewater treatment, due to its rapid growth, high biomass production, and ability to tolerate polluted conditions. Fragrant fledge is effective at removing heavy metals, nutrients such as nitrogen and phosphorous, organic matters (COD/BOD), and hydrocarbon and phenolic compounds from water. The phytoremediation and rhizofiltration of three selected plants were observed and they showed that they have heavy metal concentration at their roots, highest bio-concentration of more than 81.06, symptoms of heavy metal toxicity were not observed on any plant treatment and control. They are truly heavy metal accumulator and organic pollutants absorption plants.

Continuing with FIG. 1, in situ floating vessel 300 has a special design of turbulence aeration to increase the amount of oxygen in a polluted area 111. Turbulence aeration is a critical process for improving water quality in polluted area 111 by introducing oxygen to facilitate the breakdown of organic pollutants. This method operates by increasing turbulence flow using devices such as aerators or propellants and hollow waveguide tubes. This combination increase the contact areas between air and water, allowing oxygen to dissolve, and causing harmful gases to escape. The aerator and the phytoremediation plants of the present invention are designed to treat the polluted water.

Still referring to FIG. 1, floating vessel 300 is designed to detect other polluted sections 113 of a waterway 101 and autonomously move there. After finishing treating pollution area 111, floating vessel 300 is autonomously moving to search for next polluted are 113. Polluted area 113 may be in distant wards and districts that border waterway 101. In another aspect, polluted areas 113 may be contiguous to polluted area 111. In many aspects, as the whole waterway 101 is heavily polluted, polluted area 111 and 113 may become one. As such, many floating vessels 300 may be deployed at different locations. By the law of diffusion, pollutants will be diffused to floating vessels 300. Consequently, floating vessels 300 report the current pollution treatment to the control center. FIG. 2 to FIG. 6 describe the method and floating vessel of the present invention in details. In may preferred embodiments of the present invention, floating vessel 300 includes a decision unit and an autonomous navigation unit (ANU) that enable floating vessel 300 to detect the next pollution area 113. ANU allows floating vessel 300 to move to polluted area 113 by itself and avoid collisions with other floating vessels and obstacles.

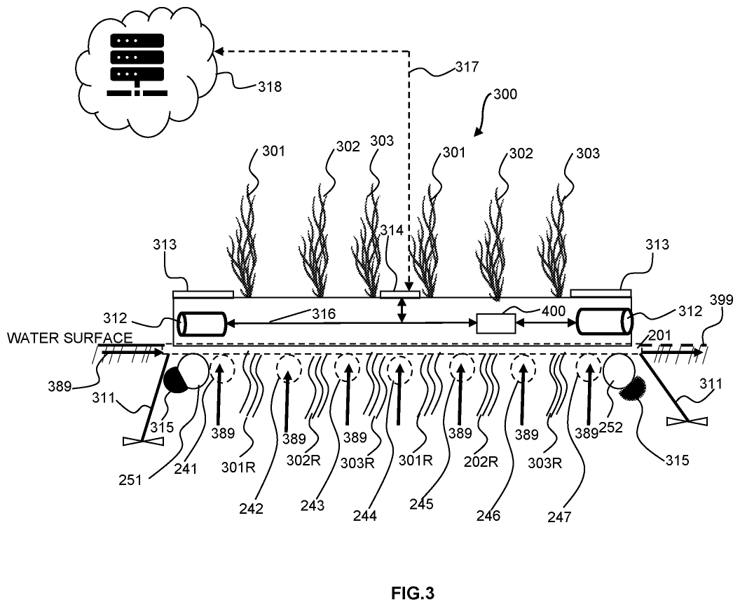

Now referring to FIG. 3, a top down view of a floating base 300 for treating pollution in waterway in accordance with an exemplary embodiment of the present invention is illustrated. Accordingly, floating base 200 includes an outer frame 210 with outer longitudinal bars 211, 212 and 213 secured to outer vertical bars 114-115. An inner floor 220 is formed inside outer frame 210 by a series of vertical floor bars 221-234 secured to outer longitudinal bars 211-213 and outer vertical bars 214-215 at a fixed distance so as to create an array of plant pots 270. A first pontoon 261 and a second pontoon 262 are secured to two extreme ends of floating base 200. A series of horizontal hollow tubes 241-244 are laid parallel to outer longitudinal bars 211-213. A series of vertical hollow tubes 251, 252, 253, 264, 265, 266, and 267 are laid parallel to outer vertical bars 214-215 and at the bottom of outer frame 210. Adjacent to first pontoon 261, vertical bars 231 and 232 are secured parallel and at a closer distance than that of vertical bars 221-230. Adjacent to second pontoon 262, pair of vertical bars 233-234 secured parallel and at a closer distance than that of vertical bars 221-230.

Continuing with FIG. 2, in many preferred embodiments of the present invention, outer frame 210 and inner floor 220 are made of bamboo (Poeceae). First pontoon 261 and second pontoon 252 are designed as load-bearing and buoyant that ensures structural safety. They are made of hollow aluminum (Al) cylinders, high density polyethylene (HDPE), fiberglass also known as fiber reinforced plastic (FRP) or other durable, corrosion free recreational materials. Horizontal hollow tubes 241-244 and vertical hollow tubes 251, 252, 253, 254, 255, 256, and 257 are designed to circulate and aerate water underneath floating base 200. They are made of artificial materials such as rubber mats, plastic pipes such as PVC (Polyvinyl chloride), high density plastic PE (polyester), PP (polypropylene), and PS (polystyrene), PVC (Polyvinyl chloride), PE (polyester), PP (polypropylene), PS (polystyrene), or carbon fiber-reinforced polymer (CFRP). In other embodiments of the present invention, floating base 200 is bamboo raft-type floating structure assembled by floating raft (FRP) concrete tubes. These hollow tubes 241-244 and 251-257 act as waveguide when combined with aerators they increase turbulence in the still polluted water. The turbulence increases dissolved oxygen (DO) and breaks down organic pollutants, removes harmful gases, and supports aquatic ecosystems.

Continuing with FIG. 2, in many preferred embodiments of the present invention, floating base 200 has the following parameters: outer longitudinal bars 211, 212, and 213 have a length of 3,500 mm, with outer/inner diameter of 50/48 mm. Outer vertical support bars 214-215 have a length of 1,650 mm an inner/outer diameter of 40/38 mm. For inner floor 220, vertical floor bars 221-234 have a length of 1,650 mm with an outer/inner diameter of 30/15 mm. First pontoon 261 and second pontoon 162 are made of HDPE plastic and have dimensions of 1,600 mm×300 mm×200 mm (length×width×height). Vertical hollow tubes 251-257 are made of PVC plastic and has a dimension of 1,680 mm and inner/outer diameter of 40/38 mm. Similarly, horizontal hollow tubes 241-244 has a length of 3,500 mm and an inner/outer diameter of 40/38 mm. Each plant pot of array of plant pots 270 is made of PE plastic and has a dimension of 466 mm×303 mm×120 mm (length×width×height). Accordingly, the total mass of floating base 200 is 82.4 kg with total buoyancy force is approximately 2,354.4 N, the gravitational force acting on floating base 200 is approximately 808.3 N, and the load-bearing mass is approximately 157.6 kg.

Horizontal hollow tubes 241-244 and vertical hollow tubes 251, 252, 253, 254, 255, 256, and 257

Next, referring to FIG. 3, a 2D diagram of the complete floating vessel 200 that includes floating base, selected plants, aerators, and other electronic devices in accordance with an exemplary embodiment of the present invention is illustrated.

Floating vessel 300 includes floating base 200 described above in FIG. 1 and FIG. 2 loaded with selected plants 301, 302, and 303 grown in matrix of plant pots 270. The thickness (width) of floating base 200 and the heights of each plant 301-303 should be selected so that the roots of plants 301, 302, and 303 are submerged in polluted water 399. In various preferred embodiments of the present invention, plant 301 is Umbrella papyrus (Cyperus alternifolius), plant 302 is fragrant flatsedge (Cyperus odoratus), and plant 303 is canna lily (Canna generalis). These plants are found to be excellent phytoremediation and waste water recycling properties. That is, they can reduce the concentrations of toxic effects of contaminants in the water of polluted area 111. More specifically, the umbrella sedge (Cyperus alternifolius) is selected and it belongs to the sedges family that can collect copper (Cu), manganese (Mn), nitrogen

$$( {NH}_{4}^{+} - N ) ,$$

and phosphorous

$$( {PO}_{4}^{3 -} ) ;$$

and achieve high removal rates for pollulants: CDO (67%-83%), TSS (61.7%). Another plant is selected is the canna lily (Canna generalis) that can remove lead (Pb), carbon (C), nitrogen (N), and phosphor (P) (CNP). Canna lily can also reduce biochemcial oxygen demand (BOD) and chemical oxygen demand (COD more than 50%). BOD and COD measure organic pollution in water with higher values indicating higher pollution. BOD measures the oxygen used by microorganisms to decompose organic matter. COD measures oxygen required from chemical oxidation of organic compounds. Fragrant fledge or fragrant flatsedge (Cyperus odoratus) is highly efficient plant widely used in phytoremediation, particularly to wastewater treatment, due to its rapid growth, high biomass production, and ability to tolerate polluted conditions. Fragrant fledge is effective at removing heavy metals, nutrients such as nitrogen and phosphorous, organic matters (COD/BOD), and hydrocarbon and phenolic compounds from water. The phytoremediation and rhizofiltration of three selected plants were observed and they showed that they have heavy metal concentration at their roots, highest bio-concentration of more than 81.06, symptoms of heavy metal toxicity were not observed on any plant treatment and control. They are truly heavy metal accumulator plants.

The selected plants are intercropped, distributed, and combined on floating platforms to form vegetation mats with the quantity and density shown in Table 2.

TABLE 1
Number and the Densities of the Selected Plants Per Vessel

| | Quantity (Plants/floating | |
|---|---|---|
| | vessel 100) | Density (Plants/m²) |
| Canna Lily (Canna | 16 | 5 |
| generalis) | | |
| Umbrella Papyrus | 24 | 5 |
| (Cyperus | | |
| alternifolius) | | |
| Fragrant flatsedge | 10 | 2 |
| (Cyperus ordoratus) | | |

Continuing with FIG. 3, inside floating base 200, there are an electronic controller 400 electrically connected to front and rear cameras 312, front and rear detectors 315, front and rear aerators 312, a transceiver 314, and solar panels 313. Transceiver 314 communicates data from cameras 312, detectors 315 to a control center 318 via a communication link 317. Control center 318 may be a cloud network, a server, an office, or a data center. Communication link 317 maybe wireless such as 5G/6G cellular network. In some embodiments of the present invention, control center 318 may be server on a patrol boat nearby and wireless communication link 317 may be Wi-fi, Bluetooth, ZigBee, or Zwave. Transceiver 314 also receives instructions and information from control center 318.

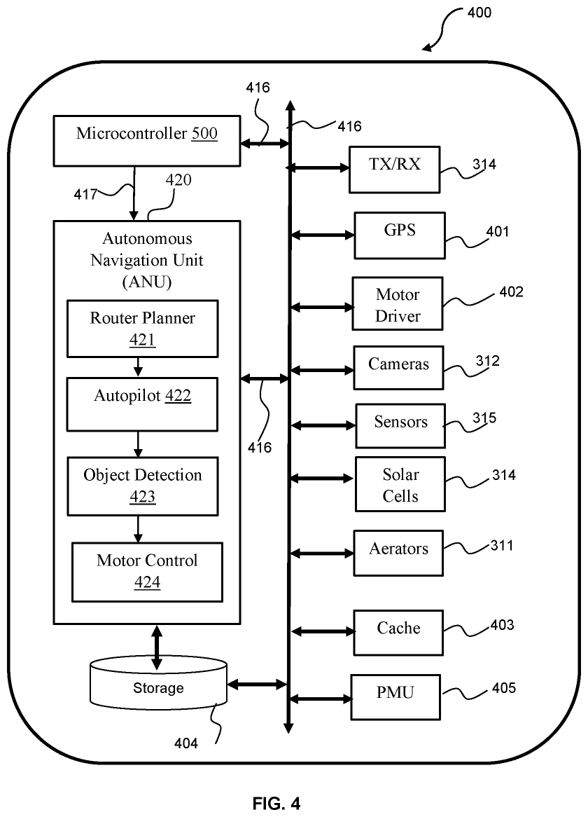

Next, referring to FIG. 4, a schematic diagram of controller box 400 in accordance with an exemplary embodiment of the present invention is illustrated. Controller box 400 receives voltage supplies from solar panels 318 and functions to (a) collect information at the polluted areas 111 and 113, (b) operate aerators 311, cameras 312, detectors 315, (c) position floating vessel 300, and (d) autonomously move floating vessel 300 to the next polluted area 113 using its sensors 315 and ANU 420.

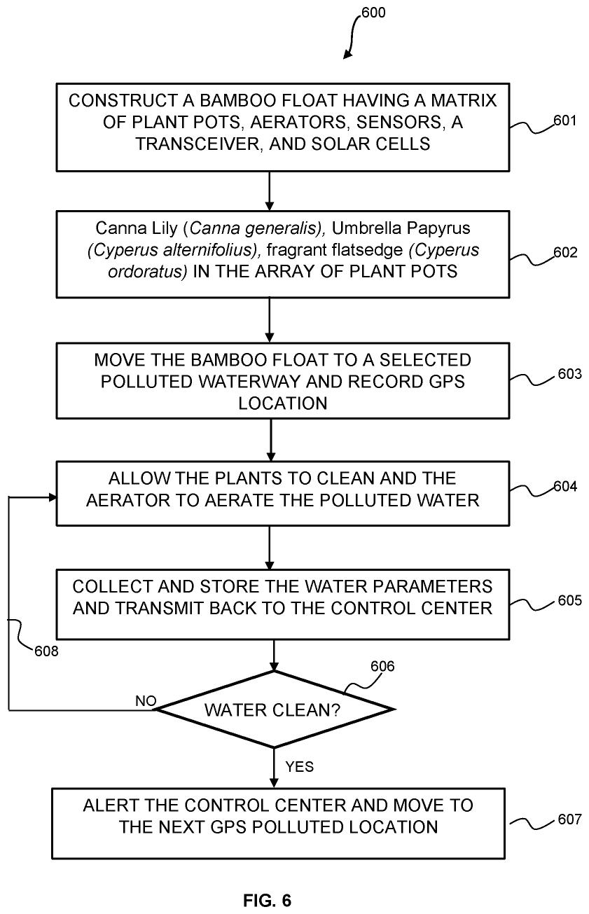

Controller box 400 includes a microcontroller 500 designed to operate transceiver (TX/RX) 314, cameras 312, sensors 315, solar cells 314, and aerators 311. Controller box 400 also includes GPS unit 401, a motor driver unit 402, a short term cache memory 403, a system memory 404, and a power management unit (PMU) 405. GPS unit 401 receives its current global positioning satellites (GPS) coordinates and transmits them to control center 318 and to an autonomous navigation unit (ANU) 420. Motor driver unit 402 receives instructions from ANU 420 to navigate floating vessel 300. In many embodiments of the present invention, motor driver unit 402 also control aerators 311. Short term cache memory 403 stores temporary data and program instructions (see FIG. 6) for fast executions. System memory 404 are long-termed memories for storing 3D maps, instructions described in FIG. 6, and other operating system instructions. Power management unit (PMU) 405 manages supply voltages and power for controller box 400.

Controller box 400 also includes an autonomous navigation unit (ANU) 420 which includes a route planner unit 421, an autopilot unit 422, an object detection unit 423, and a motor control unit 424. All listed electronic components are connected together by electrical cables 416. Electrical cables 416 are photovoltaic cables (PV) suitable for solar panels 413. Route planner unit 421 is an AI-driven system that integrates real-time data, high-definition maps stored in system memory 404, GPS data 401, and sensor fusion to calculate the next paths. Autopilot unit 422 utilizes cameras 312 such as radar and LiDAR to sense the environment of waterway 101 and keep floating vessel 300 moving within the appropriate route created by route planner 421. Object detection unit 423 enables real-time identification and localization of obstacles along waterway 101. Object detection unit 423 receives inputs from cameras 315, LIDAR, and radar and processed by YOLO deep learning algorithm. Object detection unit 423 operates by identifying objects and obstacles and mapping them with bounding boxes for safe navigation. Motor control unit 424 receives data from route planner unit 421 and object detection unit 423 to issues instructions to motor driver 402.

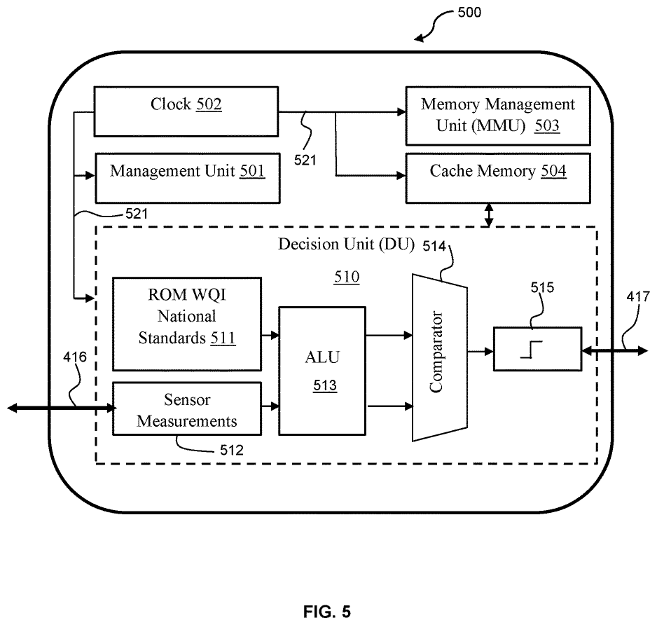

Now referring to FIG. 5, a schematic diagram of a microcontroller 500 that contains a decision unit (DU) in accordance with an exemplary embodiment of the present invention is illustrated.

Microcontroller 500 includes a control unit 501, a clock 502, a memory management unit 503, fast cache memory 504, and a decision unit 510; all connected together by internal bus 521. Control unit 501 is the brain that directs the flow of data and decodes instructions from the entire controller box 400. Clock 502 synchronizes all internal operations of microcontroller 510 by generating a steady clock signal. Memory management unit 503 translates logical addresses to physical addresses, which manages how microcontroller 400 accesses system memory. Fast cache memory 504 stores frequently used instructions such as method 600 and sensor data to minimize access time from slower RAM and memories. Internal bus 521 are internal electrical connections for transferring data, instructions, and addresses between the listed components.

Continuing with FIG. 5, decision unit (DU) 510 further includes a WQI ROM 511, a sensor measurement unit 512, an arithmetic logic unit (ALU) 513, a comparator 514, and a rectified linear unit (ReLU) 515. WQI ROM 511 stands for water quality index read only memory. ROM 511 is a memory that stores the national standards weights for water qualities. Table 2 lists a few exemplary weight scores of the water quality index (WQI).

TABLE 2
Weight Scores of the nine WQI Parameters

| Parameter | Weight |
|---|---|
| Dissolved Oxygen (DO) | 0.17 |
| Coliforms | 0.16 |
| Biochemical oxygen demand (BOD) | 0.11 |
| pH | 0.11 |
| Temperature | 0.1 |
| Nitrates | 0.1 |
| Phosphates | 0.1 |
| Turbidity | 0.08 |
| Total solids (TDS) | 0.07 |

Continuing with FIG. 5, in many exemplary embodiments, ALU 503 receives the data from sensors 315 and performs the following calculations:

$$WQI = {\sum }_{i = 1}^{n} {W}_{i} {Q}_{i}$$

where WQI is a numerical value between 0-100, Wᵢ is the weighting factor for each parameter from Table 1; Qᵢ is either quality index from the national standards and from the measured Qᵢ obtained from sensors 315. Comparator 514 measures the differences between measured WQI and national standards WQI listed in Table 3-Table 4. Finally, ReLU 515 decides whether the measured WQI surpasses the national standards by a predetermined difference. If this predetermined difference is within the allowed range, meaning the water is clean. ReLU 515 issues a command signal to autonomous navigation unit (ANU) 420. ANU 420 moves floating vessel 300 to next polluted area 113.

It is noted that the weights for each parameters, the calculations in ALU 514, and the ReLU 515 can be different values, calculations, and functions, depending on the weather the situations of the waterways. ReLU 515 can be a Schmidtt trigger, a tanh(x), sigmoid functions, and other triggering functions. All of these variations are within the scope of the present invention.

Referring now to FIG. 6, a flowchart of a method 600 for in situ remedying polluted waterways in accordance with an exemplary aspect of the present invention is illustrated. Method 600 is based on floating base 200 described above in FIG. 2 that place particular phytoremediation plants in direct contact with the contaminated water so that the plants can reduce the amounts COD and BOD. In addition, method 600 simultaneously guide the flows the contaminated water to increase the amount of dissolved oxygen in the water. Furthermore, method 600 autonomously moves the floating vessel 300 along the waterway to the next polluted section. Please refer back to FIG. 1 and FIG. 5. Also, method 600 sends water parameters data and the pollution location back to control center 318. In order to achieve these objectives, method 600 includes the following steps:

At step 601, a floating raft having a matrix of planting pots, aerators, sensors, cameras, communication devices, and solar cells are constructed. Step 401 is realized by floating draft 300 with matrix of plant pots 270, aerators 311, sensors 315, cameras 312, communication devices 314, and solar cells 313. Floating vessel 300 includes a floating base 200 and accessories as described in FIG. 2. It is noted that sensors 315 include total suspended solid (TSS) sensor (ZDYG-308701 QX), ammonium ion sensor, digital pH sensor (BH-485-PH), temperature sensor, COD sensors (CODS-3000-01 UV), etc. These sensors are commercially available and shall not be discussed in details herein.

Next at step 602, three selected phytoremediation plants are selected to grow in matrix of planting pots. Step 602 is realized by Canna lily (Canna generalis), umbrella sedge (Cyperus alternifolious), and fragrant flatsedge (Cyperus ordoratus). These plants are found to be excellent phytoremediation and waste water recycling properties. That is, they can reduce the concentrations of toxic effects of contaminants in the water of polluted area 111. More specifically, the umbrella sedge (Cyperus alternifolius) is selected and it belongs to the sedges family that can collect copper (Cu), manganese (Mn), nitrogen

$$( {NH}_{4}^{+} - N ) ,$$

and phosphorous

$$( {PO}_{4}^{3 -} ) ;$$

and achieve high removal rates for pollulants: CDO (67%-83%), TSS (61.7%). Another plant is selected is the canna lily (Canna generalis) that can remove lead (Pb), carbon (C), nitrogen (N), and phosphor (P) (CNP). Canna lily can also reduce biochemcial oxygen demand (BOD) and chemical oxygen demand (COD more than 50%). BOD and COD measure organic pollution in water with higher values indicating higher pollution. BOD measures the oxygen used by microorganisms to decompose organic matter. COD measures oxygen required from chemical oxidation of organic compounds. Fragrant fledge or phytoremediation, particularly to wastewater treatment, due to its rapid growth, high biomass production, and ability to tolerate polluted conditions. Fragrant fledge is effective at removing heavy metals, nutrients such as nitrogen and phosphorous, organic matters (COD/BOD), and hydrocarbon and phenolic compounds from water. The phytoremediation and rhizofiltration of three selected plants were observed and they showed that they have heavy metal concentration at their roots, highest bio-concentration of more than 81.06, symptoms of heavy metal toxicity were not observed on any plant treatment and control. They are truly heavy metal accumulator plants.

At step 603, floating draft is moved to a polluted water course. Step 603 is realized by GPS unit 401 that determines the location of floating vessel 300, sensors 315, camera 312, and microprocessor 500 with decision unit (DU) 514.

At step 604, allow the aerators and the phytoremediation plants to treat the polluted water. Aerators 611 stir up the polluted still water to dissolve oxygen (DO) into the water while the selected plants reduce the pollutants. The combination of above described phytoremediation plants 301-303 and aerators 311 implements step 604. Turbulence aeration illustrated by flows 389 is a critical process for improving water quality in polluted area 111 by introducing oxygen to facilitate the breakdown of organic pollutants. This method operates by increasing turbulence flow using devices such as aerators or propellants and hollow waveguide tubes. This combination increase the contact areas between air and water, allowing oxygen to dissolve, and causing harmful gases to escape. The aerator and the phytoremediation plants of the present invention are designed to treat the polluted water

At step 605, the water parameters are collected and transmitted back to a control center. Step 605 is realized by sensors 315 and communication device (TX/RX) 614. Sensors 315 can be submerged IoT sensors such as pH sensor, conductivity, DO, residual chlorine, alkalinity, turbidity, COD, ammonia nitrogen, total phosphorous, total nitrogen, and other heavy metal detectors/meters.

At step 606, whether the water has been remedied reaches a predetermined hygienic level is determined. Step 606 is realized by analyzers located at the control center. Alternatively, these analyzers can be programmed inside microcontroller 500 and storage 423. Typically, the chemical and bacteria contaminants are set by Vietnam national quality standards (QCVN 08.2023/BTNMT).

At step 607, if the water has achieved the predetermined quality, the control center is alerted and autonomously moved to another polluted waterway. Step 407 is realized by aerators 311, GPS 401, and autonomous navigation unit (ANU) 420. Cameras 312 are used to detect obstacles and avoid unwanted collision in the waterway. In step 607, environmental agents in controller center 318 can replace the current plants with new plants and perform total check-up for the floating vessel 300. In many preferred embodiments of the present invention, cameras 312 can be LiDAR 3D mapping and other perception sensors designed to avoid unwanted collision.

At step 608, if the water is not yet meet the local cleanliness standards, steps 604-606 are repeated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

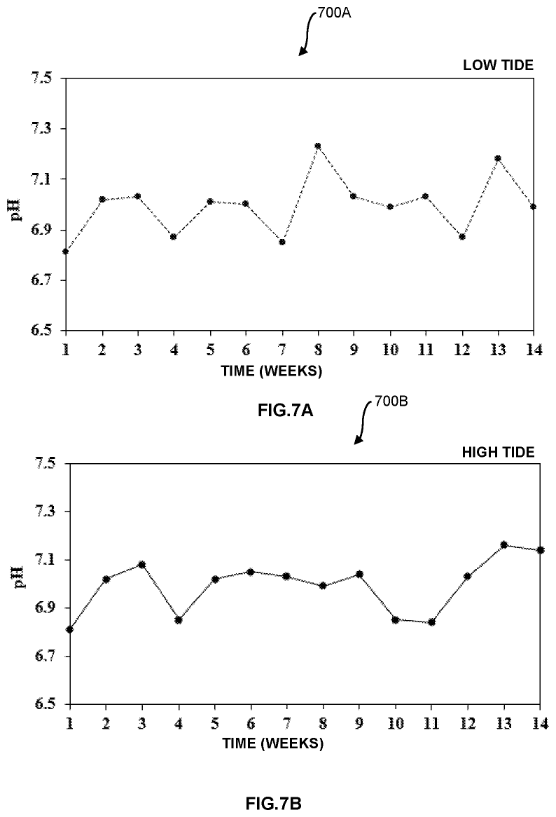

FIG. 7A-FIG. 7B to FIG. 10A-FIG. 10B show the results of floating vessel 200 in a polluted canal in Ho Chi Minh City.

Floating vessel 300 was transported to Hang Bang canal on Phan Van Khoi Street, Ward 5, District 6, Ho Chi Minh City, Vietnam. Located near residential areas and with numerous commercial activities taking place around the canal, the vessel was used for testing the treatment of organic matter in the water. The canal water is typically black, with parameters shown in Table 3. The foul odor not only affects the lives of surrounding residents but also threatens public health. The canal surface is littered with wastes, including styrofoam packaging, plastic bottles, and nylon packaging. The canal's water flow fluctuates with high and low tides twice daily. The canal receives water from two sources at either end, with continuous inlet and outlet gates and drainage pipes along both banks.

TABLE 3
Parameters of the Water Quality of Hang Bang Canal

| | | | Vietnam Standards |
|---|---|---|---|
| Parameters | Unit | Value | 08:2023/BTNMT |
| pH | | 7.1 ± 0.1 | 6.0-8.5 |
| DO | mg/L | 0.37 ± 0.20 | ≥4.0 |
| TSS | mg/L | 21.5 ± 6.8 | >100 và có rác n [symbol] i |
| COD | mg/L | 80 ± 31 | ≤20 |
| NH₄_{⁺}—N | mg/L | 22.1 ± 2.1 | 0.3 |
| NO₂_{^{−}}—N | mg/L | 0.018 ± 0.007 | 0.05 |
| NO₃_{^{−}}—N | mg/L | 0.04 ± 0.01 | |
| TN | mg/L | 24.6 ± 1.7 | ≤2.0 |
| TP | mg/L | 2.4 ± 0.6 | >0.5 |
| Fe | mg/L | 0.47 ± 0.33 | 0.50 |
| E. coli | CFU/100 ml | 45,675 ± 5,816 | 20 |

The water in Hang Bang Canal has COD, TN, and TP exceeding the permissible limits according to QCVN 08:2023/BTNMT at level D. The water quality is very poor and can significantly affect fish and other aquatic organisms due to low dissolved oxygen and high pollutant concentrations. The water may be used for waterway transportation and other purposes requiring low water quality. Furthermore, the remaining indicators are at levels hazardous to human health, except for Fe and Nitrite, which did not exceed the limits during the sampling period. The TN:TP ratio>7.3:1 indicates an excess of N, suggesting that the excess or surplus of one substance at a relatively high concentration is the cause of eutrophication and water pollution. Table 4 shows the sampling frequency for analysis and water quality assessment when the floating vessel 200 was deployed on the Hang Bang canal.

TABLE 4
Sample Method of Water of Hang Bang Canal

| Standards | Unit | Method/Apparatus | Frequency |
|---|---|---|---|
| pH | — | YSI 550A | 2 times/week |
| DO | mg/L | HM-20P | 2 times/week |
| Water level | m | Tape Measure | 2 times/week |
| COD | mg/L | ISO 8467:1993 (E) | 2 times/week |
| Plant Heights | cm | Tape Measure | 1 times/month |

Operation and evaluation of plant growth and organic matter processing capacity. The Hang Bang canal has two tidal regimes per day (two high tides and two low tides), and its tidal regime depends mainly on the tidal regime of the Lo Gom canal. Due to the operating conditions of the model, water level measurements were only taken at one high tide and one low tide. FIG. 3.6 shows the change in water level between the two tides in the Hang Bang canal. At low tide, the average water level measured in the canal was approximately 1.03±0.12 m, and at high tide, it was approximately 2.05±0.1 m. Thus, the difference in water level between high and low tide is 1.99 times.

FIG. 7A is a graph 700A showing the change in pH value for 14 weeks in a waterway at low tide using the floating vessel and method in accordance with an exemplary aspect of the present invention.

FIG. 7B is a graph 700B showing the change in pH value for 14 weeks in a waterway at low tide using the floating vessel and method in accordance with an exemplary aspect of the present invention. According to FIG. 7A-FIG. 7B, the graphs 700A-700B shows the change in pH values in the Hang Bang canal and at the floating vessel 300 during 14 weeks of operation at high and low tides according to an exemplary aspect of the present invention are shown. In FIG. 7A, graph 700A shows the pH value of the Hang Bang canal measured at low tide. It was observed that the pH value did not fluctuate significantly between weeks of operation. Graph 700A shows that there is no difference in pH between locations with and without the floating vessel 300. The measured pH values at locations with and without the floating vessel 300 were approximately 7.0±0.1. It was observed that placing the floating vessel 300 in the Hang Bang canal did not affect the pH value of the canal water. In FIG. 7B, graph 700B shows that the pH value of the Hang Bang canal measured at high tide. Graph 500B shows that the pH values did not fluctuate significantly between weeks of operation. However, at low tide in graph 700A, the pH value fluctuates relatively strongly between weeks of operation. The main cause of this phenomenon is the growth of phytoplankton, which assimilates carbon into biomass, thus reducing the CO₂ concentration in the water column and, in turn, increasing the pH over the weeks. The pH concentration changed insignificantly, possibly due to the continuous changes in the water in the channel.

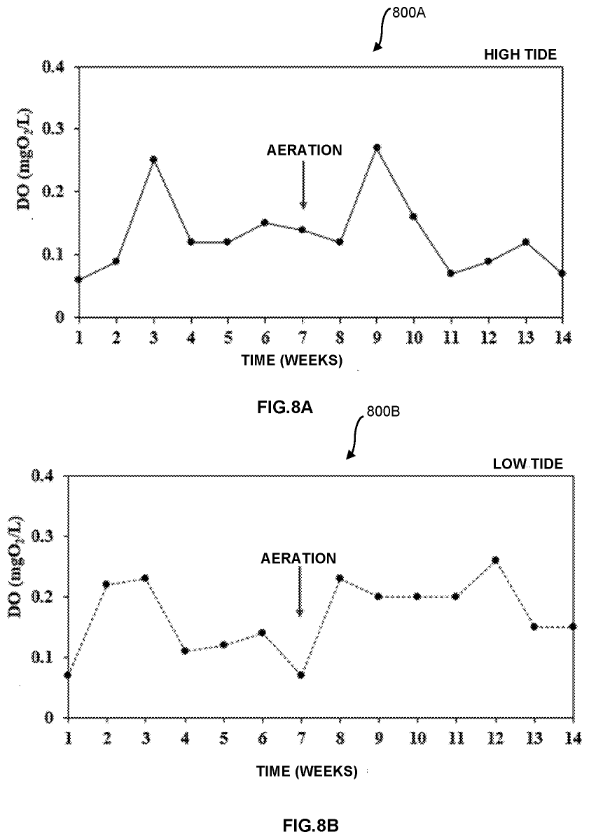

FIG. 8A is a graph 800A showing the change in dissolved oxygen (DO) value for 14 weeks in a waterway during high tide cycle using the floating vessel and method according to an exemplary aspect of the invention.

FIG. 8B is a graph 800B showing the change in dissolved oxygen (DO) value for 14 weeks in a waterway during low tide cycle using the floating vessel and method according to an exemplary aspect of the invention. According to FIG. 800A-FIG. 800B, the graphs 800A-800B show the change in dissolved oxygen (DO) concentration in water at floating vessel 300 over 14 weeks of operation at high and low tides respectively.

Graph 800A shows that the dissolved oxygen concentration at high tide was approximately 0.12±0.05 mgO₂/L. Graph 600B shows the DO concentration at low tide approximately 0.15±0.06 mgO₂/L. Together, graph 800A and graph 800B show that the water level also directly affected dissolved oxygen concentration in water. That is, higher water levels create larger anaerobic/oxygen-deficient zones below the plant roots, reducing DO in the water. Floating vessel 300 used materials to create the raft frame and buoyancy to reduce the surface area for oxygen diffusion from the air into the water, which can lead to lower DO levels at lower raft locations compared to areas without oxygen. The dissolved oxygen (DO) values measured at floating vessel 300 fluctuated around 0.14±0.06 mg/L. Because floating vessel 300 was positioned to receive the first sunlight in the canal, the higher density of vegetation on floating vessel 300 promoted efficient oxygen transport from the upper parts such as stems and leaves to the roots, thus increasing the DO concentration. Additionally, on some days, the dissolved oxygen levels at this measurement location were lower than at other locations due to the continuous flow in the canal, resulting in higher DO concentrations.

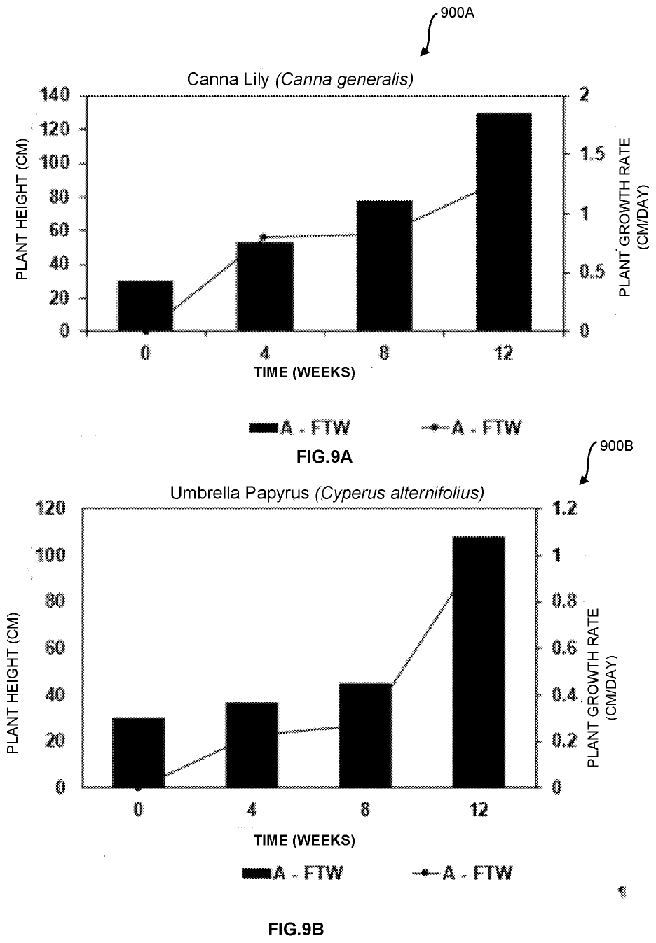

FIG. 9A is a graph 900A showing the growth of Canna Lily (Canna generalis) on the floating vessel for 14 weeks of operation according to an exemplary aspect of the present invention.

FIG. 9B is a graph 900B showing the growth of Umbrella Sedge (Cyperus alternifolius) on the floating vessel for 14 weeks of operation according to an exemplary aspect of the present invention. Now referring to FIG. 9A-FIG. 9B, graphs 900A-900B show the change in height and growth of hybrid flowering banana and Umbrella papyrus on floating vessel 300 over 14 weeks of operation according to the invention's scheme. FIG. 9A shows that the hybrid flowering banana has good adaptation to the canal water environment. With an initial height of 30 cm at the same floating vessel size, after 12 weeks of operation, the stem height of the 100-foot floating vessel was 107.5±10.6 cm. FIG. 9B shows the growth of water bamboo after 12 weeks of operation, with a measured stem height of 107.5±10.6 cm on floating vessel 300. The results of measuring the stem height of the water bamboo on floating vessel 300 indicated good growth. However, during the 8 weeks of operation, the water bamboo plants on the floating vessel 200 showed slow growth, reaching a height of 45±7 cm in the 8th week. This phenomenon could be explained by the fact that plants 301-303 on floating vessels 300 were new and had not been acclimatized to the Hang Bang canal water before being planted in the experiment, so the plants 301-303 needed time to acclimate, resulting in slow growth in the early weeks. With the relatively good growing environment on floating vessel 300, the plant species 301-302 developed uniformly, with average growth rates of approximately 1.29±0.17 cm/day for Canna lily 302 and 1.01±0.14 cm/day for Umbrella papyrus 301.

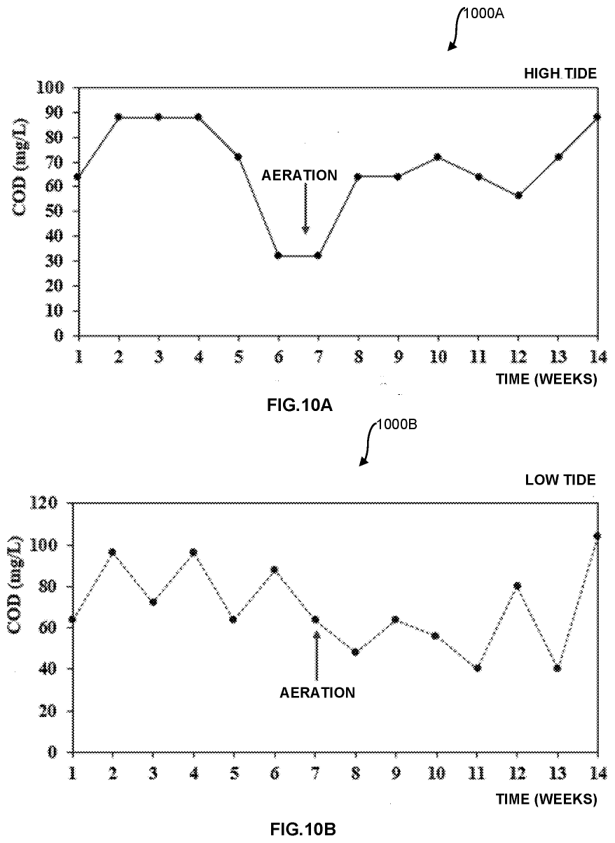

FIG. 10A is a graph 1000A showing the change in chemical oxygen demand (COD) value for 14 weeks in a waterway during high tide cycle using the floating vessel and method according to an exemplary aspect of the invention.

FIG. 1000B is a graph 1000B showing the change in chemical oxygen demand (COD) value for 14 weeks in a waterway during low tide cycle using the floating vessel and method in accordance to an exemplary aspect of the invention

Next referring to FIG. 10A-FIG. 1000B, graphs 1000A-1000B showing the fluctuations in COD concentration over 14 weeks of operation in respective high tide and low tide cycles in accordance with some aspects of the present invention are illustrated. Due to the influence of the continuous flow of the channel, the determination of the effectiveness of floating vessel 300 in supporting COD reduction in the channel water was affected. However, some weeks with stable channel flow allowed for stable concentration measurements at sampling locations, it was clearly observed that floating vessel 300 did influence on reducing organic pollution in the channel water.

In graph 1000A, in the third week of operation, at high tide, the measured COD concentration was 88 mg/L in the channel. In the area of floating vessel 200, the COD concentration decreased to 68 mg/L-64 mg/L. In addition, the COD result in week 9, which was 80 mg/L measured at the location of floating vessel 300, decreased to 48 mg/L-40 mg/L. Similarly, in week 12, the COD concentration decreased from 80 mg/L to 56 mg/L.

This experiment demonstrated the effectiveness of floating vessel 300 in reducing COD concentration in canal water through mechanisms applied to organic pollution treatment, such as: suspended organic matter colliding with plant roots during flow and then settling to the bottom sediment. Plant roots provide an ideal environment for bacteria to decompose and absorb organic matter. Bacteria use organic matter as an energy source and convert it into inorganic compounds, some of which are absorbed by plants for growth. The COD removal efficiency in week 9, after the aerators 311 supplied air, was 40.0% at high tide and 37.5% at low tide. COD removal depends on the oxygen content in the system, which affects the diversity of composition and activity of microorganisms on the biofilm of the root or rhizome surface for each aquatic species. COD is mainly removed by the oxygen content during the aerobic decomposition of pollutants. Floating vessel 300 meets the requirements for buoyancy and high load-bearing capacity, facilitating maintenance, operation, and harvesting. The frame material withstands environmental changes, creating favorable conditions for plant growth and ensuring suitability for operation, maintenance, and harvesting.

### Effectiveness of the Invention

Floating vessel 300 and method 600 as described in the invention, helps to minimize organic pollutants in canal water. Floating vessel 300 is suitable for operation in canal water environments, with materials that are highly durable in water and an operating time of approximately 4 months under real-world conditions affected by surrounding environmental factors. Floating vessel 200 has contributed to improving canal water conditions by reducing the amount of organic pollutants in the canal water with an efficiency of approximately 24.8±11.7%. In addition, the solar-powered raft has also contributed to increasing the treatment efficiency of the 100-liter floating vessel by enhancing oxygen supply through the use of a continuous aeration device.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should, therefore, be construed in accordance with the appended claims and any equivalents thereof.

### REFERENCE NUMERALS

100 polluted waterway
200 floating base
210 outer frame
211 outer longitudinal bar
212 outer longitudinal bar
213 outer longitudinal bar
214 outer vertical longitudinal bar
215 outer vertical longitudinal bar
220 floor
221-134 vertical floor bars
241-142 longitudinal hollow tubes
251-157 vertical hollow tubes
261 first pontoon
262 second pontoon
300 floating vessel
301 Canna lily (Canna generalis)
302 Umbrella papyrus (Cyperus alternifolius)
303 fragrant flatsedge (Cyperus odoratus)
311 aerators
312 cameras
313 solar panels
314 transceiver
315 sensors (detectors, meters)
316 electrical wires
317 wireless communication link
318 control center
389 turbulence aeration flows
399 water level
400 controller box
401 GPS unit
402 motor driver
403 cache memory
404 system memory
405 power management unit (PMU)
416 input communication links to microcontroller (μC)
417 output communication link from microcontroller (μC)
420 autonomous navigation unit (ANU)
421 route planner
422 autopilot
423 object detection
424 motor control
500 microcontroller
502 memory device
510 decision unit (DU)
511 ROM containing national water standards
512 measured water qualities from sensors
513 arithmetic logic unit (ALU)
514 comparator
515 ReLU (rectified linear unit)

What is claimed is:

1. A method for treating a waterway, comprising:
(a) preparing a floating vessel that has a plurality of plant pots, aerators, sensors, cameras, an electronic controller box, and a plurality of vertical and horizontal hollow tubes, said vertical and horizontal hollow tubes submerged underwater and operate as waveguides;
(b) moving said floating vessel to a first polluted water location on said waterway;
(c) growing canna lily (Canna generalis), Umbrella papyrus (Cyperus alternifolius), fragrant sedge (Cyperus ordoratus) in said plurality of plant pots so that their roots are submerged underwater at said first polluted water location;
(d) allowing said canna lily (Canna generalis), Umbrella papyrus (Cyperus alternifolius), fragrant sedge (Cyperus ordoratus) to remedy said first polluted water location at said waterway and using said sensors to monitor a quality of said first polluted water location at said waterway; and
(e) aerating said waterway using said aerators and said plurality of vertical and horizontal hollow tubes.

2. The method of claim 1 further comprising the steps of:
(f) determining whether said first polluted water location at said waterway has achieved a predetermined water quality;
(g) when said first polluted water location at said waterway has achieved said predetermined water quality, informing a control center and autonomously move said floating vessel to a second polluted location; otherwise, continue to treat said first polluted location.

3. The method of claim 2 further comprising:
(h) communicating said quality of said water to said controller center; and
(i) storing said quality of said first polluted water location at said waterway in a memory storage inside said electronic controller box.

4. The method of claim 3 further comprising recording a GPS positions of said floating vessel in said first polluted location and in said second polluted location.

5. The method of claim 4 wherein said autonomously moving said floating vessel to said second polluted position further comprises using said GPS location of said floating vessel, an autonomous navigation unit (ANU), and said motors.

6. The method of claim 5 wherein said autonomously moving said floating vessel to said second polluted position further comprises using said cameras and said ANU to avoid colliding with other objects on said waterway.

7. The method of claim 6 wherein said ANU is electrically coupled to control said motor and a rudder of said floating vessel.

8. The method of claim 7 wherein said (a) preparing a floating vessel step further comprises:
(j) preparing an outer frame; and
(k) preparing a floor secured to said outer frame, wherein said floor further comprises a plurality of vertical floor bars secured to a plurality of horizontal bars that secured together at a preset distance that form rooms for said plurality of plant pots.

9. The method of claim 8 further comprises: securing a first pontoon at one edge of said floating vessel and securing a second pontoon at an opposite edge of said floating vessel.

10. The method of claim 9 wherein said step of preparing said floor further comprises setting the distance of a first pair of said plurality of vertical bars that is next to said first pontoon closer than the remaining plurality of vertical bars.

11. The method of claim 10 wherein said step of preparing said floor further comprises setting the distance of a second pair of said plurality of vertical bars that is next to said second pontoon closer than the remaining plurality of vertical bars.

12. A floating vessel for treatment of polluted waterway, comprising:
(a) a floating base that has an outer frame and a floor encircled by said outer frame;
(b) canna lily (Canna generalis), Umbrella papyrus (Cyperus alternifolius), fragrant sedge (Cyperus ordoratus) placed in a plurality of plant pots formed by said floor;
(c) a plurality of hollow tubes mechanically coupled to an underside of said floating water; and
(d) at least one aerators, mechanically coupled to said floating base, operable to cause water to move in and out of said plurality of hollow tubes.

13. The floating vessel of claim 12 wherein said floating base further comprises a first pontoon coupled to a first edge of said floating base and a second pontoon coupled to a second edge opposite to said first edge of said floating base.

14. The floating vessel of claim 13 wherein said floor further comprises a plurality of vertical floor bars mechanically coupled to said outer frame at a constant distance so as to form said plurality of plant pots.

15. The floating vessel of claim 14 further comprises at least one cameras.

16. The floating vessel of claim 15 further comprises at least one water quality meters mechanically coupled to said floating base and submerged underwater.

17. The floating vessel of claim 16 further comprising:
an electronic controller box;
at least one motors for moving said floating base along said waterway;
a transceiver coupled to said controller box; and
a plurality of solar panels electrically coupled to provide power supplies to said controller box, said at least one motors, said at least one cameras, said at least one water quality meters, and said at least one aerators.

18. The floating vessel of claim 17 wherein said electronic controller box further comprises:
an autonomous navigation unit (ANU);
a microcontroller;
a GPS unit operable to set coordinate positions of said floating vessels along said waterway;
a memory operable to store water quality data; and
a power management unit (PMU) operable to receive said voltage supplies from said plurality of solar panels and distributes to said at least one motors, said at least one cameras, said at least one water quality meters, and said at least one aerators.

19. The floating vessel of claim 18 wherein said ANU further comprises a software program stored in said memory operative to navigate said floating vessel along said waterway in accordance with said GPS unit.

20. The floating vessel of claim 19 further comprising at least one rudders electrically coupled to be controlled by said ANU and said at least one motors.
